(19) United States
(12) Patent Application Publication
(10) Pub. No.: US 2025/0307607 A1
(43) Pub. Date: Oct. 2, 2025

(54) GENERATING A DIGITAL POSTER INCLUDING MULTIMODAL CONTENT EXTRACTED FROM A SOURCE DOCUMENT

(71) Applicant: Adobe Inc., San Jose, CA (US)

(72) Inventors: Vijay Jaisankar, Bengaluru (IN); Varre Suman Chaitanya, Konaseema Ambedkar District (IN); Kalp Sachinkumar Vyas, Bangalore (IN); Sambaran Bandyopadhyay, Bangalore (IN); Shwetha Somasundaram, Chennai (IN)

(21) Appl. No.: 18/619,667

(22) Filed: Mar. 28, 2024

(51) Int. Cl. G06N 3/0455

(52) U.S. Cl. CPC G06N 3/0455

(57) ABSTRACT

The present disclosure relates to systems, non-transitory computer-readable media, and methods for generating digital posters from digital documents with multimodal content using a deep submodular function. Specifically, the disclosed systems generate embedding vectors representing multimodal content of a digital document comprising text and images. Further, disclosed systems determine, utilizing a deep submodular function on the embedding vectors, a content subset comprising one or more digital images aligned with one or more text segments representative of the digital document. Moreover, the disclosed systems generate, utilizing a large language model, a summary of the multimodal content of the digital document from a prompt based on the content subset. Additionally, the disclosed systems generate, for display at a client device, a digital poster comprising the summary of the multimodal content generated via the large language model.

### BACKGROUND

Recent years have seen significant improvements in generative artificial intelligence technology. For example, many entities utilize generative neural networks to generate summaries of text, images, music, and/or videos. To illustrate, many entities utilize large language models to generate text summaries of large passages of text provided to the systems and images or videos based on text prompts. Summarizing digital content with computer-aided processes, however, is a challenging task that often produces inaccurate results. For example, although generative neural networks are capable of generating various types of content based on input prompts, generating the prompts to produce the desired results (e.g., via prompt engineering) typically requires a thorough understanding of how the generative neural networks operate (e.g., based on the internal architectures of the generative neural networks) or specific training processes on curated training datasets. Additionally, conventional systems that utilize generative neural networks to generate and/or summarize digital content have a number of technical deficiencies with regard to generating content from long and complex documents with multimodal content such as text and images.

### SUMMARY

Embodiments of the present disclosure provide benefits and/or solve one or more of the foregoing or other problems in the art with systems, non-transitory computer-readable media, and methods for generating digital posters from digital documents with multimodal content using a deep submodular function. In particular, in some embodiments, the disclosed systems extract multimodal content including digital images and text from a digital document. Further, in some implementations, the disclosed systems utilize an encoder neural network to embed the extracted digital images and text of the digital document into a single embedding space. Moreover, in one or more embodiments, the disclosed systems utilize the deep submodular function to determine a content subset of the embedded multimodal content that summarizes the digital document according to a coverage component, a diversity component, and an alignment component of the deep submodular function. In some embodiments, the disclosed systems provide the content subset to a large language model to generate a multimodal summary based on the content subset. Furthermore, in one or more implementations, the disclosed systems generate a digital poster using elements of the summary (i.e., summary elements such as digital images and text boxes) by providing the summary to various models such as a layout determination model, a font selection model, and a color selection model.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a digital poster generation system operates in accordance with one or more embodiments.

FIG. 2 illustrates a process flow of generating a digital poster from a digital document with multimodal content using a deep submodular function in accordance with one or more embodiments.

FIG. 3 illustrates the digital poster generation system extracting multimodal content from a digital document in accordance with one or more embodiments.

FIG. 4 illustrates the digital poster generation system embedding multimodal content in a single embedding space in accordance with one or more embodiments.

FIG. 5 illustrates the digital poster generation system determining a content subset utilizing a deep submodular function on the embedding vectors in accordance with one or more embodiments.

FIG. 6 illustrates the digital poster generation system determining design elements for a digital poster from a multimodal content summary in accordance with one or more embodiments.

FIG. 7 illustrates generating a digital poster from a layout and design elements in accordance with one or more embodiments.

FIG. 8 illustrates an example schematic diagram of a computing device implementing the digital poster generation system in accordance with one or more embodiments.

FIG. 9 illustrates an example series of acts for generating a digital poster including a multimodal content summary in accordance with one or more embodiments.

FIG. 10 illustrates an example series of acts for generating a digital poster including a multimodal content summary in accordance with one or more embodiments.

FIG. 11 illustrates an example series of acts for generating a digital poster including a multimodal content summary in accordance with one or more embodiments.

FIG. 12 illustrates a block diagram of an example computing device for implementing one or more embodiments of the present disclosure.

### DETAILED DESCRIPTION

This disclosure describes one or more embodiments of a digital poster generation system that generates digital posters from digital documents with multimodal content using a deep submodular function. In particular, in some embodiments, the digital poster generation system extracts multimodal content including digital images and text from a digital document. Additionally, in some implementations, the digital poster generation system utilizes an encoder neural network to encode the extracted digital images and text of the digital document into a single embedding space. Further, in one or more embodiments, the digital poster generation system utilizes the deep submodular function to select a content subset of the embedded multimodal content that provides sufficient coverage of the content, diversity within the content, and aligns the digital images with corresponding portions of the text. In these or other embodiments, the digital poster generation system uses a large language model to generate a summary of the digital document based on the content subset. The digital poster generation system generates a digital poster using elements of the summary (i.e., summary elements such as digital images and text boxes) by using a plurality of models (e.g., a font selection model, and a color selection model, and a layout determination model) to determine visual attributes and a layout of the summarized content.

As mentioned above, in some embodiments, the digital poster generation system utilizes an encoder neural network to embed multimodal content (e.g., extracted digital images and text) of a digital document into a single embedding space. Specifically, the digital poster generation system extracts the digital images and the text from the document. Furthermore, in some implementations, the digital poster generation system generates text segments from the text of the document. Additionally, in one or more embodiments, the digital poster generation system provides both the digital images and the text segments to the encoder neural network to embed the digital images and the text segments into a single embedding space.

Further, in one or more implementations, the digital poster generation system determines a content subset of the embedded multimodal content according to a coverage component, a diversity component, and an alignment component of a deep submodular function. In particular, the digital poster generation system utilizes the deep submodular function to select embedding vectors including both image vectors and text segment vectors that summarize the digital document. For example, in some embodiments, based on the coverage component of the deep submodular function, the digital poster generation system determines embedding vectors that collectively summarize the digital document. Furthermore, in some implementations, based on the diversity component of the deep submodular function, the digital poster generation system determines embedding vectors that provide diversity of the content subset by minimizing repetition of meaning across the determined embedding vectors. Additionally, in one or more embodiments, based on the alignment component of the deep submodular function, the digital poster generation system determines text segment vectors that align with image vectors.

As noted above, in one or more implementations, the digital poster generation system generates a digital poster using summary elements (e.g., digital images and text boxes) by providing the summary to various machine learning models. For example, in some embodiments, in response to receiving the summary of the content subset from the large language model, the digital poster generation system provides the summary to the various models. To illustrate, in some implementations, the digital poster generation system provides the summary to a layout determination model to determine a layout of the digital poster based on the summary elements, attributes of the summary elements, etc. Further, in one or more embodiments, the digital poster generation system provides the summary to a font selection model and a color selection model to determine fonts and colors of the digital poster. In these or other embodiments, the digital poster generation system generates the digital poster for display on a client device using the determined layout, fonts, and colors.

Although some conventional systems utilize generative neural networks to generate various types of content and/or summarize text content, such systems have a number of problems in relation to accurately generating content from complex sources. For instance, conventional systems often require pre-processing steps to convert information from complex sources into a structured format defined by a schema to generate content to conform to a specific output. Similarly, other conventional systems rely on template retrieval from a fixed set of templates to generate a specific output, such as an output conforming to a specific style or formatting. Even so, such conventional systems often require input data of a single type, such as only text or only images, and do not allow for content generation based on multimodal input. Moreover, while some conventional systems attempt to utilize complex (e.g., multimodal) data input, these systems have additional constraints such as allowing only inputs of a specific formatting (e.g., for research papers) or generating outputs including data of only a single modality or a limited data subset of one or more modalities. Furthermore, conventional systems also often lack the ability to flexibly generate designs of outputs from complex sources.

In addition to their constraints with generating content form complex sources, conventional systems often do so inaccurately. More specifically, even conventional systems designed to summarize multimodal content are often trained on a single modality and therefore introduce modality bias into summaries. Moreover, conventional systems often focus on selecting content from complex sources based on a single factor such as coverage or diversity and therefore introduce inaccuracies by exemption of crucial information. Furthermore, even when conventional systems are capable of limited multimodal content generation, these systems introduce inaccuracies because they lack the ability to align the content across modalities. These conventional systems are also often subject to other common inaccuracy introducing problems such as hallucination during summary generation or requiring highly specified prompts.

As suggested by the foregoing, the digital poster generation system provides a variety of technical advantages relative to conventional systems. Specifically, in one or more implementations, the digital poster generation system utilizes a combination of models to generate digital posters including content from complex (e.g., having multimodal content) sources. For example, in contrast to conventional systems that require content to be in a structured format, the digital poster generation system uses a single embedding space with a deep submodular function to process multimodal content in a schema-free format. In particular, the digital poster generation system utilizes a combination of models to perform content extraction, encoding, selection, summarization, and formatting in an end-to-end process capable of handling data structured in a variety of different formats.

Further, in some implementations, the digital poster generation system accurately detects relevant summary content from multimodal content in a digital document via a deep submodular function. For example, the digital poster generation system embeds the extracted multimodal content into a single embedding space, which allows the digital poster generation system to determine relevant multimodal content without the need to distinguish between different modalities. Moreover, in one or more embodiments, by utilizing the deep submodular function to determine the relevant multimodal content, the digital poster generation system optimizes the selection according to a plurality of parameters including coverage of the document, diversity of selected content portions, and alignment of the selected portions across modalities.

Furthermore, the digital poster generation system provides improved flexibility of computer-aided content generation processes by utilizing machine-learning to determine design elements and layouts from summarized content of a digital document. For example, the digital poster generation system utilizes a variety of models, including machine learning models, to generate multimodal content designs (e.g., a digital poster) that is consistent with the content of a digital document. In contrast to conventional systems that utilize one-size-fits-all approaches to presenting generated content or focus on single modality content, the digital poster generation system generates digital posters with aesthetically consistent (e.g., in fonts, styles, colors, layout) content relative to the source material.

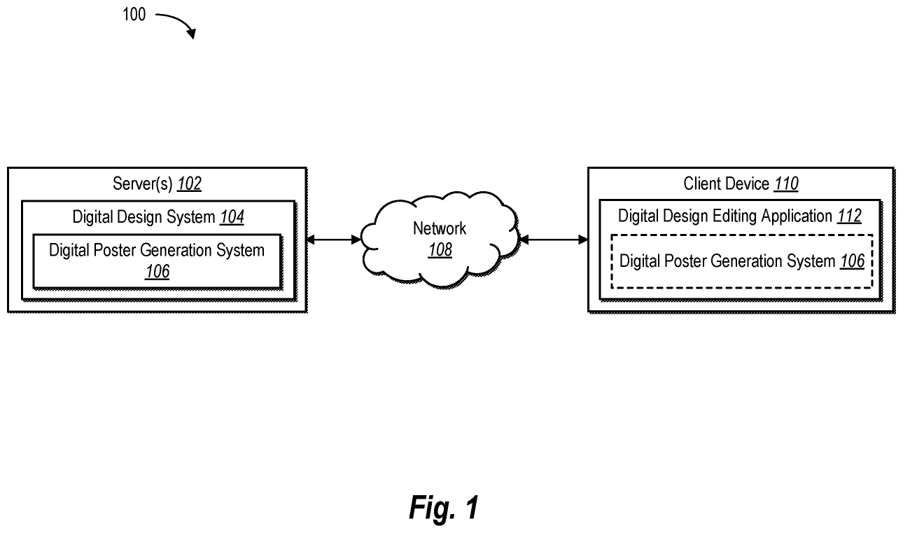

Additional detail regarding the digital poster generation system will now be provided with reference to the figures. For example, FIG. 1 illustrates an example system environment 100 in which a digital poster generation system 106 operates in accordance with one or more embodiments. As illustrated in FIG. 1, the environment 100 includes a server(s) 102, a network 108, and a client device 110. Although the environment 100 of FIG. 1 is depicted as having a particular number of components, the environment 100 is capable of having any number of additional or alternative components (e.g., any number of servers, client devices, or other components in communication with the digital poster generation system 106 via the network 108). Similarly, although FIG. 1 illustrates a particular arrangement of the server(s) 102, the network 108, and the client device 110, various additional arrangements are possible.

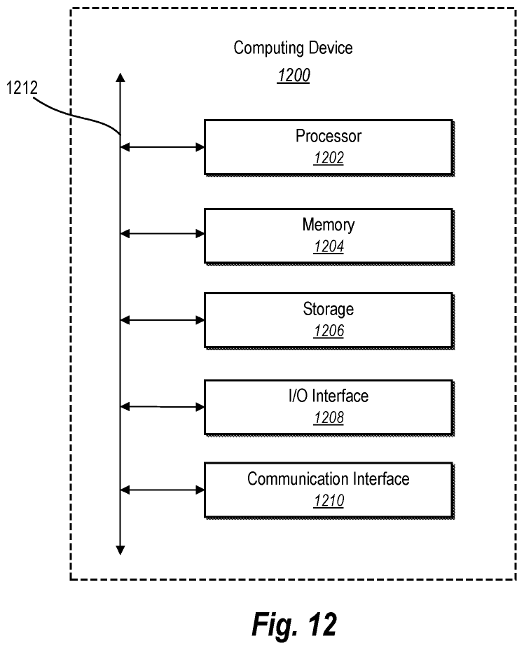

The server(s) 102, the network 108, and the client device 110 are communicatively coupled with each other either directly or indirectly (e.g., through the network 108 discussed in greater detail below in relation to FIG. 12). Moreover, the server(s) 102 and the client device 110 include one or more of a variety of computing devices (including one or more computing devices as discussed in greater detail with relation to FIG. 12).

As mentioned above, the environment 100 includes the server(s) 102. In one or more embodiments, the server(s) 102 generates, stores, receives, and/or transmits data including notifications, models, and digital content. In one or more embodiments, the server(s) 102 comprises a data server. In some implementations, the server(s) 102 comprises a communication server or a web-hosting server. Further, the server(s) 102 includes a digital design system 104, which further includes the digital poster generation system 106.

In one or more embodiments, the client device 110 includes computing devices that access, edit, segment, modify, store, and/or provide, for display, digital content such as digital posters. For example, the client device 110 includes smartphones, tablets, desktop computers, laptop computers, head-mounted-display devices, or other electronic devices. The client device 110 includes one or more applications (e.g., a digital design editing application 112) that access, edit, segment, modify, store, and/or provide, for display, digital content such as digital posters. For example, in one or more embodiments, the digital design editing application 112 includes a software application installed on the client device 110. Additionally, or alternatively, the digital design editing application 112 includes a software application hosted on the server(s) 102 accessible by the client device 110 through another application, such as a web browser.

To provide an example implementation, in some embodiments, the digital poster generation system 106 on the server(s) 102 supports the digital poster generation system 106 on the client device 110. In other words, the client device 110 obtains (e.g., downloads) the digital poster generation system 106 from the server(s) 102. Once downloaded, the digital poster generation system 106 on the client device 110 generates digital posters by determining subsets of multimodal content from digital documents, providing the content subsets to a large language model, and determining layouts, fonts, and colors of the digital posters.

In alternative implementations, the digital poster generation system 106 includes a web hosting application that allows the client device 110 to interact with content and services hosted on the server(s) 102. To illustrate, in one or more implementations, the client device 110 accesses a software application supported by the server(s) 102. In response, the digital poster generation system 106 on the server(s) 102 generates and provides a digital poster. The server(s) 102 then provides the digital poster to the client device 110 for display.

To illustrate, in some cases, the digital poster generation system 106 on the client device 110 determines a content subset of a digital document via a software application supported by the server(s) 102. The client device 110 transmits the content subset to the server(s) 102. In response, the digital poster generation system 106 on the server(s) 102 further generates a summary of the content subset (e.g., via a large language model) to generate a digital poster by providing the summary to various models to determine a layout, fonts, and colors of the digital poster.

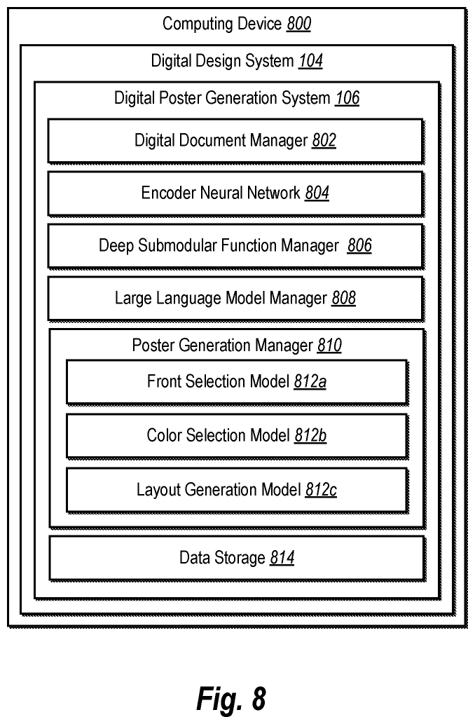

Although FIG. 1 illustrates the digital poster generation system 106 implemented with regard to the server(s) 102, different components of the digital poster generation system 106 are able to be implemented by a variety of devices within the environment 100. For example, a different computing device (e.g., the client device 110) or a separate server from the server(s) 102 implement one or more (or all) components of the digital poster generation system 106. Indeed, as shown in FIG. 1, the client device 110 includes the digital poster generation system 106. Example components of the digital poster generation system 106 will be described below with regard to FIG. 8.

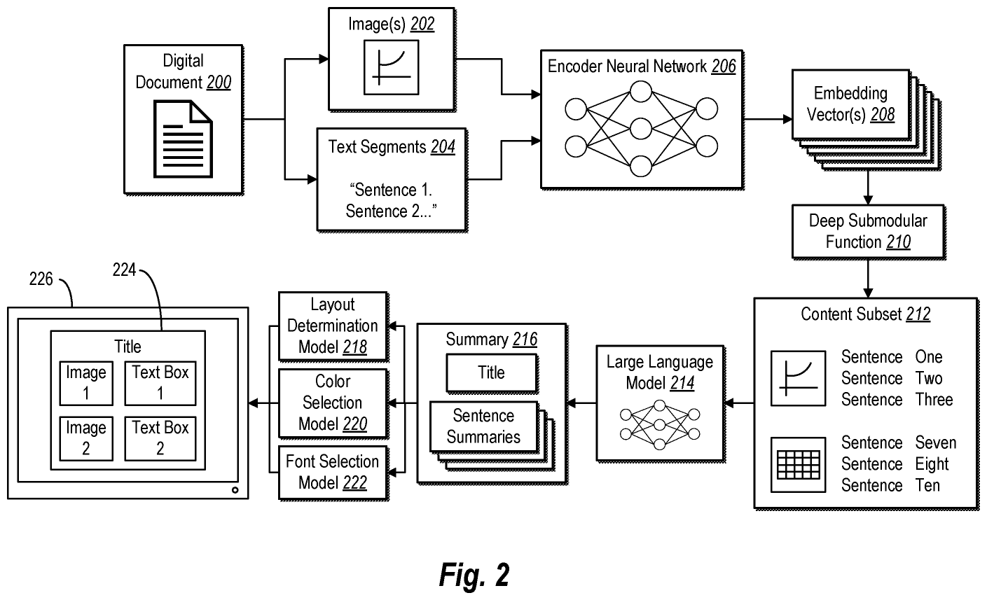

As mentioned previously, in one or more implementations, the digital poster generation system generates digital posters from digital documents with multimodal content using a deep submodular function and one or more neural networks. For example, FIG. 2 illustrates a process flow of generating a digital poster from a digital document with multimodal content using a deep submodular function in accordance with one or more embodiments.

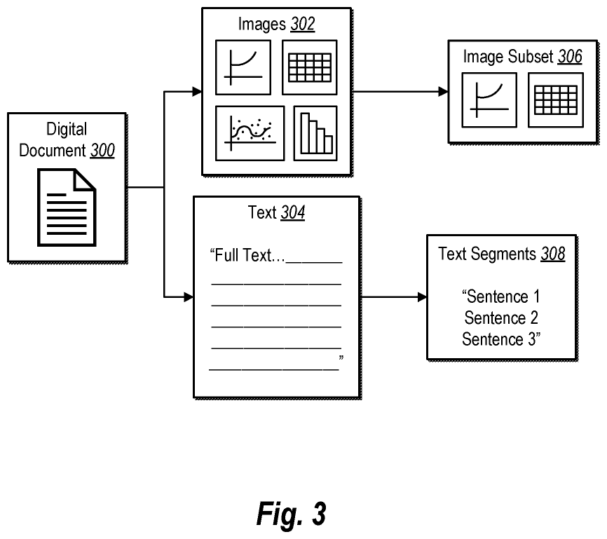

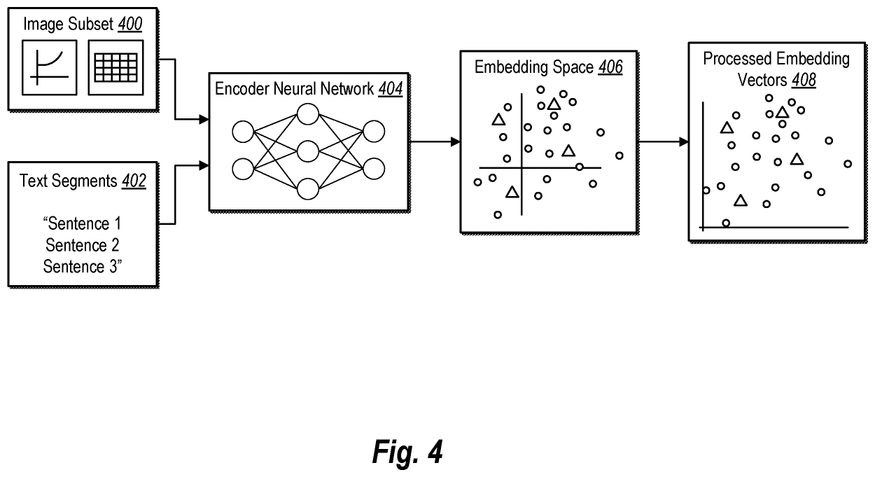

As illustrated in FIG. 2, in some embodiments, the digital poster generation system 106 extracts multimodal content from a digital document 200 to generate embedding vectors representing the multimodal content. For example, the digital poster generation system 106 extracts images 202 and text segments 204 from the digital document 200 as further discussed in FIG. 3. Furthermore, in some implementations, the digital poster generation system 106 utilizes an encoder neural network 206 to generate embedding vectors 208 of the images 202 and the text segments 204 as discussed further with respect to FIG. 4.

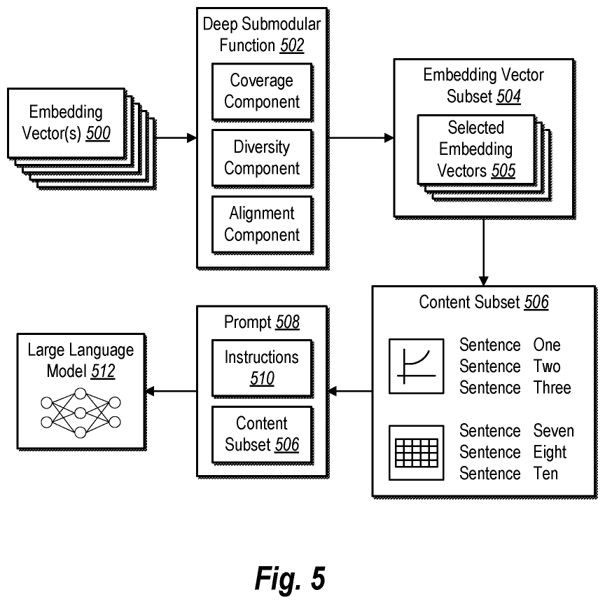

As further illustrated in FIG. 2, in one or more embodiments, the digital poster generation system 106 determines a content subset 212 from the embedded multimodal content using a deep submodular function 210 as further described in FIG. 5. In particular, in one or more implementations, the digital poster generation system 106 uses the deep submodular function 210 to determine the content subset 212 from the embedding vectors 208. Indeed, in these or other embodiments, the digital poster generation system 106 determines the content subset 212 including text (e.g., sentences) and images extracted from the digital document 200.

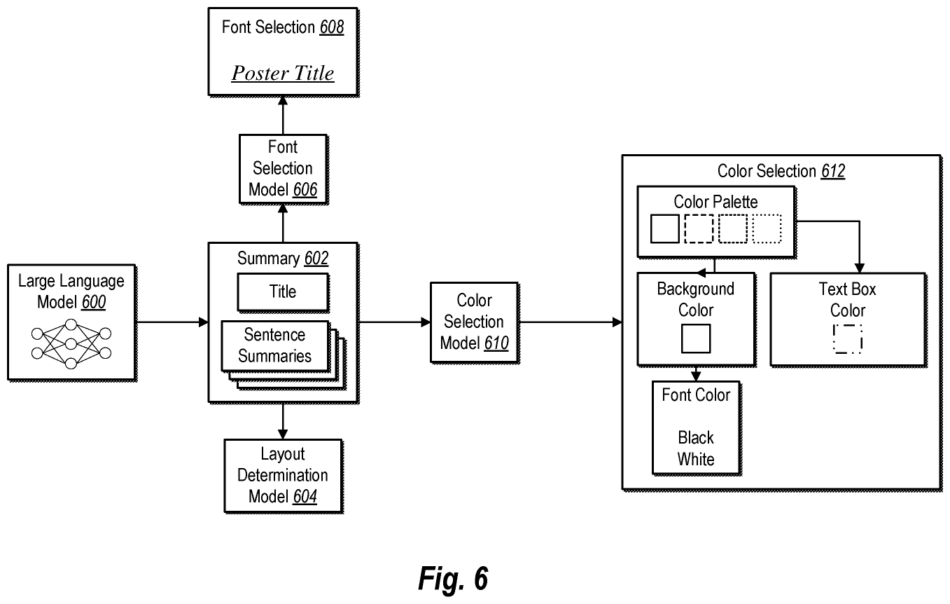

Also shown in FIG. 2, the digital poster generation system 106 generates a summary 216 from the content subset 212 using a large language model 214 as discussed in further detail with respect to FIG. 6. For example, the digital poster generation system 106 provides a prompt to the large language model 214 including the content subset 212. Additionally, in these or other embodiments, the digital poster generation system 106 generates a summary 216 of the content subset 212 utilizing the large language model 214. For instance, in some embodiments, the summary 216 includes sentence summaries with corresponding images and a title for the digital poster.

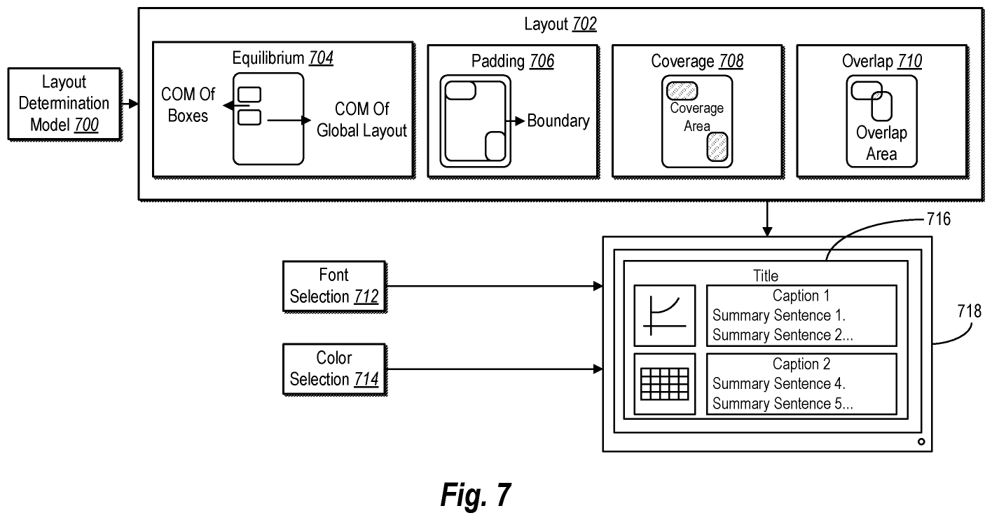

As also illustrated in FIG. 2, in some implementations, the digital poster generation system 106 generates a digital poster 224 for display on a client device 226 as discussed further with respect to FIGS. 6 and 7. Specifically, the digital poster generation system 106 provides the summary 216 to various models such as a layout determination model 218, a color selection model 220, and a font selection model 222 to determine visual attributes of the digital poster. Further, in one or more embodiments, the digital poster generation system 106 utilizes the various models to generate the digital poster 224 for display on the client device 226 from the summary 216.

As noted previously, in one or more implementations, the digital poster generation system 106 extracts multimodal content (e.g., images and text segments) from a digital document. Indeed, in some embodiments, the digital poster generation system 106 extracts the text and images from the digital document and modifies the extracted content. For example, FIG. 3 illustrates the digital poster generation system 106 extracting multimodal content from a digital document in accordance with one or more embodiments.

As illustrated in FIG. 3, in some implementations, the digital poster generation system 106 extracts multimodal content from the digital document 300. For example, the digital poster generation system 106 utilizes an application programming interface (API) to access a document analyzer (e.g., a PDF analyzer) to extract the multimodal content from the digital document 300. In these or other embodiments, the multimodal content includes images 302 and text 304 of the digital document 300. Accordingly, the document analyzer identifies text (e.g., via an OCR process) and images (e.g., via object or image recognition processes) in the digital document 300.

As further illustrated in FIG. 3, in one or more embodiments, the digital poster generation system 106 modifies the extracted images 302 and text 304. In particular, in one or more implementations, the digital poster generation system 106 modifies the images 302 by determining an image subset 306. For example, the digital poster generation system 106 determines the image subset 306 by removing some images based on image dimensions. Indeed, in these or other embodiments, the digital poster generation system 106 removes images of unusual dimensions such as images with an aspect ratio of greater than 2 or less than 0.5 (e.g., to remove banners or other images that are unlikely to contain information relevant to text in the digital document 300). In some cases, the digital poster generation system determines the image subset 306 to include all of the original extracted images 302.

Further, in some embodiments, the digital poster generation system 106 modifies the text 304 by determining text segments 308 from the extracted text 304. Indeed, in some implementations, the digital poster generation system 106 utilizes trained machine learning models to determine the text segment 308 from the extracted text 304. For example, in one or more embodiments, the digital poster generation system 106 utilizes a text parser (e.g., a natural language text processing library) to split the text 304 into individual sentences or phrases. Thus, in these or other embodiments, the text segments 308 are sentences or phrases, as illustrated in FIG. 3. Accordingly, the digital poster generation system 106 determines an image subset 306 and text segments 308 to generate embedding vectors of the multimodal content.

As just mentioned, in one or more implementations, the digital poster generation system 106 generates embedding vectors of the multimodal content. Indeed, in some embodiments, the digital poster generation system 106 generates embedding vectors from the multimodal content using an encoder neural network. For example, FIG. 4 illustrates the digital poster generation system 106 embedding multimodal content in a single embedding space in accordance with one or more embodiments.

As illustrated in FIG. 4, in some implementations, the digital poster generation system 106 generates embedding vectors by providing the multimodal content (e.g., an image subset 400 and text segments 402) to an encoder neural network 404. Indeed, in one or more embodiments, the digital poster generation system 106 utilizes an encoder neural network capable of embedding high dimensional information such as images and text into a single embedding space. For example, in one or more implementations, the digital poster generation system 106 uses a vision-language encoding model as described in U.S. patent application Ser. No. 18/443,808 to Jenni et al., which is herein incorporated by reference in its entirety, or another multimodal embedding model that encodes images and text into a unified embedding space.

Accordingly, in these or other embodiments, the digital poster generation system 106 embeds the images of the image subset 400 and the text segments 402 (e.g., sentences) into a single embedding space 406. For instance, as shown in FIG. 4, the triangles in the embedding space 406 represent image embeddings and the circles represent text segment embeddings such that downstream operations treat the images and text similarly. In some embodiments, by embedding the image subset 400 and the text segments 402 into the same embedding space 406, the digital poster generation system 106 avoids the need for separate encoding neural networks with a specialized fusion block.

As further illustrated in FIG. 4, the digital poster generation system 106 processes the embedding vectors representing the multimodal content to prepare the embedding vectors for additional operations. For example, in some implementations, the digital poster generation system 106 generates processed embedding vectors 408 by performing an origin shift. Specifically, the digital poster generation system 106 converts any negative values to non-negative values by subtracting the minimum value in the embedding matrix from all the embedding vectors to convert the values of the embedding vectors to greater than or equal to zero.

Additionally or alternatively, in one or more embodiments, the digital poster generation system 106 generates the processed embedding vectors 408 through normalization. In these or other embodiments, normalization of the embedding vectors ensures that the embedding vectors conform to a norm compatible with a deep submodular function. In particular, in one or more implementations, the digital poster generation system 106 performs L1 normalization on the embedding vectors to generate the processed embedding vectors 408.

As previously mentioned, in some embodiments, the digital poster generation system 106 determines a content subset from the embedded multimodal content using a deep submodular function. Indeed, in some implementations, the digital poster generation system 106 provides embedding vectors representing the multimodal content of the digital document to the deep submodular function to determine the content subset. FIG. 5 illustrates the digital poster generation system 106 determining a content subset utilizing a deep submodular function on the embedding vectors with a plurality of constraints on the content in accordance with one or more embodiments.

As illustrated in FIG. 5, in one or more embodiments, the digital poster generation system 106 determines an embedding vector subset 504 from embedding vectors 500 using a deep submodular function 502. In one or more implementations, the embedding vectors 500 represent processed embedding vectors (as discussed above with respect to FIG. 4) of an image subset and text segments of a digital document. Moreover, in some embodiments, the digital poster generation system 106 determines the embedding vector subset 504 of a fixed length that summarizes (i.e., has the maximum score) from the embedding vectors 500 as follows:

ƒ: 2^{V}→R

where V represents the embedding vectors 500 and R represents the embedding vector subset 504 with the maximum score for the deep submodular function 502. In one or more embodiments, the submodularity of the deep submodular function 502 allows for a simple (i.e., computationally inexpensive) solution as discussed further below.

Furthermore, in some implementations, the deep submodular function 502 includes three main components, a coverage component, a diversity component, and an alignment component that compare embedding vectors to determine similarities and/or differences among the embedding vectors in relation to various thresholds. Indeed, in one or more embodiments, the digital poster generation system 106 utilizes the coverage component of the deep submodular function 502 to determine the embedding vector subset 504 to include embedding vectors representing images and text content that collectively summarize the digital document. Indeed, in one or more implementations, the digital poster generation system utilizes the coverage component to determine the embedding vector subset 504 that represents the document as a whole by covering all of the important concepts included in the digital document.

Additionally, in some embodiments, the digital poster generation system 106 utilizes the diversity component of the deep submodular function 502 to determine the embedding vector subset 504 to include embedding vectors that provide diversity of semantic meaning across the content subset according to the diversity component. For example, the diversity component minimizes repetition of meaning across the embedding vectors of the embedding vector subset 504. Accordingly, the digital poster generation system 106 excludes duplicated semantic meanings from the content subset in response to identifying embedding vectors that represent text or images with similar semantic concepts.

Additionally, in some implementations, the digital poster generation system 106 utilizes the alignment component of the deep submodular function 502 to determine the embedding vector subset 504 to include text segment vectors and image vectors that align according to the alignment component. Indeed, in one or more embodiments, the alignment component ensures that the digital poster generation system 106 selects text segment vectors that align in meaning with selected image vectors. To illustrate, the digital poster generation system 106 determines text segments represented by the text segment vectors that provide explanation or discussion of images represented by the image vectors.

In one or more implementations, the digital poster generation system 106 utilizes the following deep submodular function:

$$f ( A ) = {\sum }_{u ∈ U} {w}_{u} \sqrt{{\sum }_{a ∈ A} {\sum }_{x ∈ V} {a}_{u} {x}_{u} - {\sum }_{a ∈ A} {\sum }_{x ∈ A} {a}_{u} {x}_{u} + {\sum }_{x ∈ {A}_{I}} {\sum }_{y ∈ {A}_{T}} {x}_{u} {y}_{u} + \vert V \vert ( {\sum }_{a ∈ A} {a}_{u} )}$$

where U is the number of embedding vectors 500, V is the space including all the embedding vectors, A is the embedding vector subset 504, wᵤ represents the weights of the submodular function, and aᵤ, xᵤ, and yᵤ are the value of the embedding vectors in the u^{th} dimension. Further, in some embodiments with reference to the deep submodular function above, the first term (in the square root function) corresponds to the coverage component, the second term corresponds to the diversity component, the third term corresponds to the alignment component, and the fourth term corresponds to a submodular component (i.e., to ensure the submodularity of the deep submodular function 502).

In some implementations, the digital poster generation system 106 determines the coverage component, the diversity component, and/or the alignment component by iteratively optimizing the embedding vector subset 504 and weights of the deep submodular function 502 to maximize the deep submodular function 502. Moreover, in one or more embodiments, the digital poster generation system 106 adjusts the parameters of the deep submodular function 502 in the framework of a neural network with the ground truth data.

In one or more implementations, the digital poster generation system 106 obtains the weights by training the deep submodular function 502 on a multimodal dataset. For example, the digital poster generation system 106 trains the deep submodular function 502 utilizing a dataset of articles with multimodal content (e.g., documents with multimodal content) and multimodal summaries. Furthermore, in some embodiments, for a given ground truth, the digital poster generation system 106 trains the deep submodular function 502 using a max margin loss based on hinge loss formulated as follows:

$${min}_{w \geq 0} {\sum }_{V , {S}^{*} ∈ T S} \{ {( {max}_{A ⊂ V} [ f ( A ) ] - f ( {S}^{*} ) )}_{+} + \frac{λ}{2} {‖ w ‖}_{2}^{2} \}$$

where A is less than or equal to K, K is a constant that the digital poster generation system 106 receives via user input, and TS is the training set consisting of tuples (multimodal document, multimodal ground truth summary). Additionally, in some implementations, the digital poster generation system 106 calculates the sub gradient h for weight wᵤ for a multimodal document/multimodal ground truth pair as:

$$h = \frac{\partial f ( A )}{\partial {w}_{u}} - \frac{\partial f ( {S}^{*} )}{\partial {w}_{u}} + λ {w}_{u}$$

As previously noted, in one or more embodiments, the digital poster generation system 106 iteratively optimizes a chosen embedding vector subset and weights of the submodular function to maximize the deep submodular function. Indeed, in one or more implementations, the digital poster generation system 106 alternates between a fixed A (e.g., a selected embedding vector subset) to minimize the loss with respect to the weights w, and a fixed w to maximize A. For example, in some embodiments, the digital poster generation system 106 minimizes an output of a loss function with respect to w for a fixed A using a projected gradient descent algorithm with a fixed learning rate as follows:

$${w}_{u} = min ( {w}_{u} - α ( \sqrt{{\sum }_{a ∈ A} {a}_{u} ( \vert V \vert + {\sum }_{x ∈ V , x ∉ A} {x}_{u} ) + {\sum }_{x ∈ {A}_{T}} {\sum }_{y ∈ {A}_{I}} {x}_{u} {y}_{u}} - \sqrt{{\sum }_{s ∈ S} {s}_{u} ( \vert V \vert + {\sum }_{x ∈ V , x ∉ S} {x}_{u} + {\sum }_{x ∈ {S}_{T}} {\sum }_{y ∈ {S}_{I}} {x}_{u} \cdot {y}_{u} )} + λ {w}_{u} ) , 0 )$$

Further, the digital poster generation system 106 maximizes, for a fixed w, ƒ (i.e., the deep submodular function) using, for example, a greedy algorithm.

In some implementations, the digital poster generation system 106 uses the foregoing methods to determine the embedding vector subset 504 according to the components (e.g., coverage, diversity, and alignment components) of the deep submodular function 502. For example, in one or more embodiments, the digital poster generation system 106 determines both image vectors and corresponding text segment vectors when determining the embedding vectors for inclusion in the embedding vector subset 504.

As further shown in FIG. 5, in one or more implementations, the digital poster generation system 106 determines the content subset 506 from the embedding vector subset 504. Indeed, in some embodiments, the digital poster generation system 106 determines which images and text segments of the digital document correspond to the selected embedding vectors 505 making up the embedding vector subset 504.

As also shown in FIG. 5, in some implementations, the digital poster generation system 106 generates and provides a prompt 508 including the content subset 506 and instructions 510 to the large language model 512 for summary generation. In these or other embodiments, the digital poster generation system 106 generates instructions that direct the large language model 512 to generate a summary according to various constraints. To illustrate, in one or more embodiments, the digital poster generation system 106 generates instructions 510 with constraints such as rephrasing or paraphrasing the text segments, maintaining the order of the text segments, organizing the text segments into a specified number (or range) of topics, generating a title for each topic, specifying a range of text segments for inclusion within a topic, merging topics according to specified criteria such has having too few text segments, providing a programming language dictionary (e.g., containing topic names as keys and a python list of small bullet points as the corresponding values, maintaining syntax of a python dictionary, maintaining the order of the overall content as provided, preventing hallucinations and additions, generating a summaries into a hierarchical format suitable for a poster, etc.).

As mentioned above, in one or more implementations, the digital poster generation system 106 generates a digital poster from a summary of a content subset of a digital document. Indeed, in some embodiments, to generate the digital poster, the digital poster generation system 106 determines design elements and a layout for the digital poster according to the text and images selected in the content subset. FIG. 6 illustrates the digital poster generation system 106 determining design elements for a digital poster from a multimodal content summary in accordance with one or more embodiments.

As illustrated in FIG. 6, in some implementations, the digital poster generation system 106 utilizes a large language model 600 to generate a summary 602 of the multimodal content of a digital document. Indeed, in one or more embodiments, the digital poster generation system 106 receives the summary 602 including multimodal content from the large language model 600. For example, in one or more implementations, the digital poster generation system 106 receives a summary including a title for the digital poster, text segment summaries (e.g., sentence summaries), the digital images, captions (e.g., image captions and/or text box captions), etc. In these or other embodiments, the digital poster generation system 106 receives the digital images and corresponding sentence summaries according to the alignment component of the deep submodular function (i.e., each digital image aligns with one or more specific sentence summaries). Moreover, in some embodiments, the summary 602 retains the overall order of the digital document according to the instructions of the large language model prompt.

In one or more embodiments, the large language model 600 includes an artificial intelligence model capable of processing and generating natural language text or other language-based prompts using language understanding. In particular, large language models are trained on large amounts of data to learn patterns and rules of language. As such, a large language model post-training is capable of generating output predictions that indicate visualization structures. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. In one or more embodiments, the digital poster generation system 106 utilizes a large language model as described by Jivat Neet Kaur, Sumit Bhatia, Milan Aggarwal, Rachit Bansal, and Balaji Krishnamurthy in “LM-CORE: Language Models with Contextually Relevant External Knowledge” in arXiv: 2208.06458v1, 2022, which is herein incorporated by reference in its entirety.

As further shown in FIG. 6, in some implementations, the digital poster generation system 106 provides the summary 602 to various machine learning models to determine design elements of the digital poster. For example, the digital poster generation system 106 provides the summary 602 to a font selection model 606 to determine a font selection 608 of the digital poster.

In one or more embodiments, the font selection model 606 includes a machine learning model with various components. For example, in one or more implementations, the font selection model 606 includes an encoder, a multi-layer network, and/or a normalization function. Indeed, in some embodiments, the digital poster generation system 106 utilizes a font selection model 606 including a pre-trained text encoder that generates an embedding vector, which the digital poster generation system 106 passes through a 3-layer, fully connected network with alternate dropout layers. In some implementations, this 3-layer network uses the rectified linear unit (ReLU) activation function. In one or more embodiments, the digital poster generation system 106 passes the third layer (i.e., the output of the 3-layer network) through a normalization function (e.g., a softmax function).

As noted above, in some implementations, the digital poster generation system 106 provides the summary 602 to the font selection model 606 to determine the font selection 608 of the digital poster. In some embodiments, the digital poster generation system provides a portion of the summary 602 (e.g., the title) to the font selection model 606 to determine the font selection 608. To illustrate, in one or more embodiments, the digital poster generation system 106 determines one or more key points of the digital document based on the title. Moreover, in these or other embodiments, the digital poster generation system 106 generates an embedding using the key points with the pre-trained text encoder.

Additionally, in these or other embodiments, the digital poster generation system provides the embedding from the encoder to the fully connected network. Further, the digital poster generation system 106 passes the output of the fully connected network through a softmax function and determines fonts of the font selection 608 using one or more highest index fonts. In particular, in some embodiments, the digital poster generation system 106 determines fonts such as a font for the title, topic headings, topic texts, and other text of the digital poster.

In one or more embodiments, the digital poster generation system 106 determines a plurality of fonts from which the font selection 608 can be determined. To illustrate, the digital poster generation system 106 utilizes the font selection model 606 to generate recommendations of a plurality of possible fonts from which a user can select the font selection 608. For instance, the digital poster generation system 106 determines fonts that match the content of the digital document (e.g., based on the summary 602) in relation to a threshold similarity value and provide the fonts for display via a graphical user interface.

Furthermore, in one or more implementations, the digital poster generation system 106 trains the font selection model 606 by determining and/or modifying the various parameters of the font selection model 606. For instance, in some embodiments, the digital poster generation system 106 determines the appropriate learning rate for the font selection model 606 using an LR-Finder trained on a dataset consisting of pairs of text segments and the most appropriate fonts for the text segments. Additionally, in some embodiments, the digital poster generation system 106 utilizes at least a portion of the dataset for testing.

In one or more embodiments, the digital poster generation system 106 provides the summary 602 to various machine learning models to determine additional design elements of the digital poster. For example, as illustrated in FIG. 6, in one or more implementations, the digital poster generation system 106 provides the summary 602 to a color selection model 610 to determine a color selection 612 of the digital poster.

In some embodiments, the color selection model 610 includes a machine learning model with various components. For example, in some implementations, the digital poster generation system 106 uses a color selection model 610 including a Question Answering (QA) model and a machine learning model trained on a text-to-palette generation network (TPN). In one or more embodiments, the digital poster generation system trains the TPN trained model using a dataset including pairs of text and color palettes.

In one or more implementations, the digital poster generation system 106 utilizes a multi-step method to determine the color selection 612. For example, in some embodiments, the digital poster generation system 106 provides the summary 602 (or portions of the summary such as the title of the digital poster) to the QA model to determine a main idea or intent of the of the digital poster. To illustrate, the digital poster generation system 106 determines a main idea including one or more summarized topics of the digital document based on the summary 602 (e.g., based on the title or the sentence summaries). Accordingly, in various embodiments, the main idea includes the title or one or more portions of the sentence summaries. Additionally, in some implementations, the digital poster generation system 106 provides the output of the QA model to the TPN trained model to determine the color selection 612.

As illustrated in FIG. 6, the digital poster generation system 106 determines the color selection 612 by determining a color palette. In these or other embodiments, the digital poster generation system 106 determines the color palette best suited to the main idea or intent of the digital poster as determined by the color selection model 610. Specifically, the digital poster generation system 106 utilizes the color selection model 610 to determine a color palette that matches (or corresponds to) the main idea identified for the digital poster based on a similarity score or other probability value generated by the color selection model 610. In some embodiments, the digital poster generation system 106 determines a plurality of possible color palettes for the main idea from which a user can select, similar to the font selection 608 described previously.

Further, in one or more embodiments, the digital poster generation system 106 determines a background color, a text box color, and/or a font color from the color palette. For instance, in one or more implementations, the digital poster generation system 106 determines a dominant color of the color palette using color contrast ratios. To illustrate, in some embodiments, the digital poster generation system 106 utilizes the color contrast ratios of the CIELAB color space (i.e., the color space defined by the International Commission on Illumination). Moreover, in some implementations, the digital poster generation system 106 assigns the dominant color as the background color of the digital poster.

Furthermore, in one or more embodiments, the digital poster generation system 106 utilizes the background color to determine a text box color (i.e., the fill color of the text boxes) of the digital poster. For example, in these or other embodiments, the digital poster generation system 106 determines a complementary color of the background color (the color opposite the background color on the color wheel) and assigns the complementary color as the text box color of the digital poster. In other embodiments, the digital poster generation system 106 determines another color as the text box color such as a color of the color palette, or other color, based on various principles of color theory.

Additionally, in one or more implementations, the digital poster generation system 106 determines the font color based on the text box color. For example, the digital poster generation system 106 determines which of various colors (e.g., black or white) has a higher contrast with the text box color and assigns the higher contrast color as the font color. Further, in some embodiments, the digital poster generation system 106 determines the various possible colors for the font color based on various principles of color theory.

As also illustrated in FIG. 6, the digital poster generation system 106 provides the summary 602 to a layout determination model 604. Indeed, the digital poster generation system 106 provides the summary 602 to the layout determination model 604 to determine a layout of the digital poster as further described with respect to FIG. 7.

As noted previously, in some implementations, the digital poster generation system 106 generates a digital poster from a summary of a content subset of a digital document. Indeed, in one or more embodiments, to generate the digital poster, the digital poster generation system 106 determines a layout for the digital poster. FIG. 7 illustrates generating a digital poster from a layout and design elements in accordance with one or more embodiments.

As illustrated in FIG. 7, in one or more implementations, the digital poster generation system 106 determines a layout 702 utilizing a layout model 700. As previously mentioned, in some embodiments, the digital poster generation system 106 provides the summary of the content subset to the layout model 700 to determine the layout 702. Indeed, in some implementations, based on the summary, the digital poster generation system 106 determines and generates summary elements of the digital poster 716. By way of example, and not limitation, the digital poster generation system 106 determines and generates summary elements including images, text boxes, caption boxes, bounding boxes, etc.

In one or more embodiments, the digital poster generation system 106 determines the images based on the images indicated as being part of the summary by the large language model. Moreover, in one or more implementations, the digital poster generation system 106 generates text boxes or text bounding boxes based on the text segment summaries (e.g., the sentence summaries). For example, in these or other embodiments, the digital poster generation system 106 generates the text boxes by generating a text box and inserting one or more sentence summaries in the text box.

Furthermore, in some embodiments, the digital poster generation system generates image bounding boxes and inserts corresponding images. In some implementations, the digital poster generation system also inserts an image caption in the image bounding box. In one or more implementations, the digital poster generation system also inserts a text box caption in a text bounding box associated with an image.

Further, in some embodiments, the digital poster generation system 106 determines an order of the image bounding boxes and text bounding boxes when generating the layout 702. In one or more embodiments, the digital poster generation system 106 determines the order by placing text bounding boxes with one or more sentence summaries corresponding to an image adjacent to the image bounding box in the layout 702. In additional embodiments, the digital poster generation system 106 determines the order based on an order of content in the source document or based on an order indicated by a large language model when generating a summary.

As previously noted, in some implementations, the digital poster generation system 106 generates the layout 702 using the layout model 700. In one or more embodiments, the layout model includes various formulas to determine various attributes, distances, and positions of the summary elements. For example, in one or more implementations, the layout model includes formulas to determine attributes, such as the height and width, of the summary elements as well as determining the spatial arrangement of and distancing between the summary elements as discussed further below.

Moreover, in some embodiments, the digital poster generation system 106 generates the layout 702 based on the number and attributes of the summary elements to create a balanced layout. Specifically, in some implementations, the digital poster generation system 106 determines the number of summary elements by determining the number of images (or image bounding boxes) of the summary and the number of text boxes (or text bounding boxes) generated from the sentence summaries of the summary. To illustrate, in one or more embodiments, the digital poster generation system 106 determines the number of images (i.e., N as discussed in the formulas below) and the number of text boxes (i.e., M as discussed in the formulas below).

As mentioned above, in one or more implementations, the digital poster generation system 106 determines the layout 702 by determining the attributes (e.g., dimensions) of the images (or image bounding boxes) and text boxes (or text bounding boxes). In some embodiments, the digital poster generation system 106 determines a fixed width of the text boxes. Furthermore, in some implementations, the digital poster generation system 106 dynamically determines heights of the text boxes based on the content length and the number of the text boxes as discussed in further detail below.

As noted above, in one or more embodiments, the digital poster generation system 106 determines the spatial arrangement of the summary elements in the digital poster 716. For example, in one or more implementations, the digital poster generation system 106 determines an area of the digital poster 716 for the title bounding box, leaving the remaining space (i.e., h as discussed in the formulas below) for distributing images and text boxes. Additionally, in some embodiments, the digital poster generation system 106 calculates the distance between the text boxes (i.e., dh1 as discussed in the formula's below) based on the number of text boxes (M). Similarly, in some implementations, the digital poster generation system 106 calculates the distance between the images (i.e., dh2 as discussed in the formula's below) depending on the number of images (N). In one or more embodiments, however, if the digital poster generation system determines fewer than 3 for inclusion in the digital poster 716, the digital poster generation system 106 elongates the bottom text boxes and reduces the distance between the images to ensure visual balance. Indeed, in one or more implementations, the digital poster generation system 106 utilizes the following formulas to determine the distance between the text boxes (dh1) and the distance between the images (dh2):

$$\begin{matrix}dh 1 = \frac{h - {\sum }_{i} {h}_{i}^{T}}{M + 1} \\ if N > 3 , d h 2 = \frac{h - {\sum }_{i} ( {h}_{i}^{I} + {h}_{i}^{C} ) - {k}_{1} \cdot N}{N + 1} \\ else if N \leq 2 , d h 2 = d h 1\end{matrix}$$

where hᵢ^{T}, hᵢ^{l}, and hᵢ^{c} are the estimated heights of the iₜₕ text, image, and caption box respectively. In some embodiments, the digital poster generation system 106 adds k1 to make dh2 depend on the number of images.

Further, in some implementations, the digital poster generation system 106 determines the position of the bounding boxes. For example, in one or more embodiments, the digital poster generation system 106 determines the position of the bounding boxes by determining the corners of the bounding boxes as follows:

$$\begin{matrix}{Y}_{i}^{T} = h - ( i \cdot dh 1 ) - {\sum }_{j = 1}^{i - 1} {h}_{j}^{T} \\ {Y}_{i}^{I} = h - ( i \cdot dh 2 ) - {\sum }_{j = 1}^{i - 1} ( {h}_{j}^{I} + {h}_{j}^{C} ) - ( i - 1 ) \cdot {k}_{2} \\ {Y}_{i}^{C} = {Y}_{i}^{I} - {h}_{i}^{I} - {k}_{2}\end{matrix}$$

where k2 is the gap between the images and the caption boxes. Moreover, in one or more implementations, the digital poster generation system 106 maintains the aspect ratio of the images and therefore the heights of the images depend on the width of the images.

Furthermore, as mentioned previously, the digital poster generation system 106 maintains the overall order of the images and text boxes. For example, the digital poster generation system 106 organizes the layout 702 such that the digital poster generation system 106 places an image and a corresponding text box (or boxes) that explain the image together in the layout 702 (e.g., text and images aligned as indicated by the deep submodular function).

Additionally, in some embodiments, the digital poster generation system 106 maintains the overall order by generating the order of the summary elements in the layout 702 to mirror the order of the content in the digital document.

As illustrated in FIG. 7, the digital poster generation system 106 generates the layout 702 to optimize an equilibrium 704, a padding 706, a coverage 708, and an overlap 710 of the digital poster 716. For example, the equilibrium 704 represents the distance of the center of mass (COM) of the summary elements as a whole and the COM of the layout 702. Further, the optimal padding 706 represents the area between the boundary of the layout 702 and the edges of the topmost and rightmost edges of the summary elements. Moreover, the optimal coverage 708 represents the proportion of the layout 702 covered by the summary elements. Furthermore, the overlap represents the sum of areas of intersection between the summary elements in the layout 702. In one or more embodiments, the digital poster generation system 106 utilizes the following scoring function:

$$w = {w}_{0} \cdot [ equilibrium ] + {w}_{1} \cdot [ padding ] + {w}_{2} \cdot [ density ] + {w}_{3} \cdot [ overlap ] .$$

In various experiments, the digital poster generation system 106 generates an average layout score of approximately 0.50 (on a scale of 0 to 1) compared to existing/conventional diffusion models for layout generation, which generate an average layout score of approximately 0.27 when generating digital posters. Thus, the digital poster generation system 106 provides improved layout generation performance over existing models.

As also shown in FIG. 7, the digital poster generation system 106 generates the digital poster 716 for display on a client device 718. For example, the digital poster generation system 106 generates the digital poster 716 utilizing the layout 702 as well as the font selection 712 and color selection 714 (each of which are more particularly described with respect to FIG. 6). To illustrate, the digital poster generation system 106 generates the digital poster with a title, images and text boxes as shown in FIG. 7. Indeed, the digital poster generation system 106 generates the digital poster with the selected images adjacent to corresponding text boxes. Additionally, in some implementations, each text box includes the summary sentence/s describing the corresponding image.

Furthermore, in some embodiments, the digital poster generation system 106 generates a plurality of possible layouts utilizing the layout determination model 700. The digital poster generation system 106 provides the possible layouts to the client device 718 for display. Additionally, in response to a selection of a possible layout by the client device 718, the digital poster generation system 106 generates the digital poster 716 utilizing the selected layout. In some embodiments, the digital poster generation system 106 provides the possible layouts as example digital posters (e.g., low quality samples), while in other embodiments, the digital poster generation system 106 provides the possible layouts as simple box diagrams.

Turning to FIG. 8, additional detail will now be provided regarding various components and capabilities of the digital poster generation system 106. In particular, FIG. 8 illustrates an example schematic diagram of a computing device 800 (e.g., the server(s) 102 and/or the client device 110) implementing the digital poster generation system 106 in accordance with one or more embodiments of the present disclosure for components 800-814. As illustrated in FIG. 8, the digital poster generation system 106 includes a digital document manager 802, an encoder neural network 804, a deep submodular function manager 806, a large language model manager 808, poster generation manager 810 (including a font selection model 812a, a color selection model 812b, a layout generation model 812c), and data storage 814.

The digital document manager 802 accesses a digital document with multimodal content (e.g., text and images) and extracts the multimodal content. For example, the digital document manager 802 a digital document and extracts the images and the full text of the digital document. Further, the digital document manager determines text segments from the extracted text. Moreover, the digital document manager 802 interacts with other components to provide the text segments and images for further processing.

The encoder neural network 804 generates embedding vectors representing the multimodal content. For example, the encoder neural network 804 receives the extracted text segments and images of the digital document from the digital document manager 802 and generates the embedding vectors. In particular, the encoder neural network 804 embeds the text segments and images into a single embedding space. Furthermore, the encoder neural network 804 passes the embedding vectors to other components in the digital poster generation pipeline for further processing.

The deep submodular function manager 806 receives the embedding vectors from the encoder neural network 804 and determines a content subset. For example, the deep submodular function manager 806 determines the content subset by determining an embedding vector subset of image vectors and text segment vectors. Additionally, the deep submodular function manager 806 also determines digital images and text segments (e.g., such as sentences) corresponding to the embedding vectors to determine the content subset. Further, the deep submodular function manager 806 provides the content subset of digital images and text segments to other components for further processing.

The large language model manager 808 receives the content subset and generates a summary using a large language model. For instance, the large language model manager 808 receives the content subset including the multimodal content from the deep submodular function manager 806 and generates a prompt including the content subset and instructions. Moreover, the large language model manager 808 provides the prompt to a large language model to generate a summary of the multimodal content based on the content subset and instructions. Furthermore, the large language model manager 808 receives the summary from the large language model and provides the summary to other components for further processing.

The poster generation manager 810 receives the summary and generates a digital poster utilizing various models (e.g., including a font selection model 812a, a color selection model 812b, and a layout generation model 812c). For example, the poster generation manager 810 generates the digital poster to include the summary of the multimodal content of the content subset. Additionally, the poster generation manager 810 determines design elements of the digital poster utilizing various machine learning models. Specifically, the poster generation manager 810 determines fonts and colors of the digital poster using the font selection model 812a and the color selection model 812b, respectively. Further, the poster generation manager 810 determines summary elements of the digital poster based on the summary of the multimodal content. Moreover, in one or more embodiments, the poster generation manager 810 utilizes the layout generation model 812c to determine the layout of the summary elements in the digital poster according to the attributes of the summary elements. Furthermore, the poster generation manager provides the generated digital poster for display on a client device.

The data storage 814 stores datasets, documents, embedding data, data representing multimodal content, summary data, prompt data, poster data, etc. For example, the data storage 814 stores digital documents comprising multimodal data accessed from various dataset.

Each of the components 802-814 of the digital poster generation system 106 can include software, hardware, or both. For example, the components 802-814 can include one or more instructions stored on a computer-readable storage medium and executable by processors of one or more computing devices, such as a client device or server device. When executed by the one or more processors, the computer-executable instructions of the digital poster generation system 106 can cause the computing device(s) to perform the methods described herein. Alternatively, the components 802-814 can include hardware, such as a special-purpose processing device to perform a certain function or group of functions. Alternatively, the components 802-814 of the digital poster generation system 106 can include a combination of computer-executable instructions and hardware.

Furthermore, the components 802-814 of the digital poster generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-814 of the digital poster generation system 106 may be implemented as a stand-alone application, such as a desktop or mobile application. Furthermore, the components 802-814 of the digital poster generation system 106 may be implemented as one or more web-based applications hosted on a remote server. Alternatively, or additionally, the components 802-814 of the digital poster generation system 106 may be implemented in a suite of mobile device applications or “apps.” For example, in one or more embodiments, the digital poster generation system 106 can comprise or operate in connection with digital software applications such as ADOBE® ACROBAT®, ADOBE® EXPRESS®, and/or ADOBE® DOCUMENT CLOUD®.

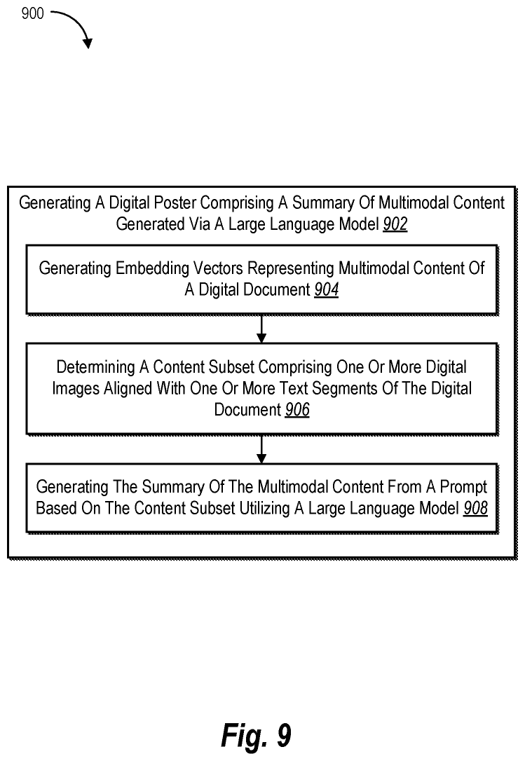

FIGS. 1-8, the corresponding text, and the examples provide a number of different systems, methods, and non-transitory computer readable media for generating digital posters from digital documents with multimodal content using a deep submodular function. In addition to the foregoing, embodiments can also be described in terms of flowcharts comprising acts for accomplishing a particular result. For example, FIGS. 9-11 illustrate flowcharts of example sequences of acts in accordance with one or more embodiments.

While FIGS. 9-11 illustrate acts according to some embodiments, alternative embodiments may omit, add to, reorder, and/or modify any of the acts shown in FIGS. 9-11. The acts of FIGS. 9-11 can be performed as part of a method. Alternatively, a non-transitory computer readable medium can comprise instructions, that when executed by one or more processors, cause a computing device to perform the acts of FIGS. 9-11. In still further embodiments, a system can perform the acts of FIGS. 9-11. Additionally, the acts described herein may be repeated or performed in parallel with one another or in parallel with different instances of the same or other similar acts.

FIG. 9 illustrates an example series of acts 900 for generating a digital poster including a multimodal content summary. The series of acts 900 can include an act 902 of generating a digital poster comprising a summary of multimodal content generated via a large language model; an act 904 of generating embedding vectors representing multimodal content of a digital document; an act 906 of determining a content subset comprising one or more digital images aligned with one or more text segments of the digital document; and an act 908 of generating the summary of the multimodal content from a prompt based on the content subset utilizing a large language model.

In some embodiments, the series of acts 900 can include generating, by at least one processor utilizing an encoder neural network, embedding vectors representing multimodal content of a digital document including text and images. The series of acts 900 can also include an act of determining, by the at least one processor and utilizing a deep submodular function on the embedding vectors, a content subset including one or more digital images aligned with one or more text segments representative of the digital document. The series of acts 900 can further include an act of generating, utilizing a large language model, a summary of the multimodal content of the digital document from a prompt based on the content subset. Additionally, the series of acts 900 can include an act of generating, by the at least one processor and for display at a client device, a digital poster including the summary of the multimodal content generated via the large language model.

In some implementations, generating the embedding vectors representing the multimodal content of the digital document includes extracting the text and the images of the digital document. The series of acts 900 can also include an act of determining text segments from the extracted text of the digital document. The series of acts 900 can further include an act of generating, utilizing the encoder neural network, the embedding vectors representing the text segments and the images in a single embedding space.

In one or more embodiments, determining the content subset includes determining, utilizing the deep submodular function, one or more embedding vectors that collectively summarize the digital document according to a coverage component of the deep submodular function. Additionally, in one or more implementations, determining the content subset includes determining, utilizing the deep submodular function, one or more embedding vectors that provide diversity of meaning across the content subset by minimizing repetition of meaning across the one or more embedding vectors according to a diversity component of the deep submodular function. Further, in some embodiments, determining the content subset includes determining, utilizing the deep submodular function, one or more text segment vectors that align with one or more image vectors according to an alignment component of the deep submodular function.

In some implementations, determining the content subset by utilizing the deep submodular function on the embedding vectors includes determining at least one of a coverage component, a diversity component, or an alignment component of the deep submodular function by iteratively optimizing a chosen embedding vector subset and weights of the submodular function to maximize the deep submodular function. Moreover, in one or more embodiments, the series of acts 900 can include adjusting parameters of the deep submodular function in a framework of a neural network by reducing an output of a loss function utilizing a projected gradient descent algorithm with a fixed learning rate.

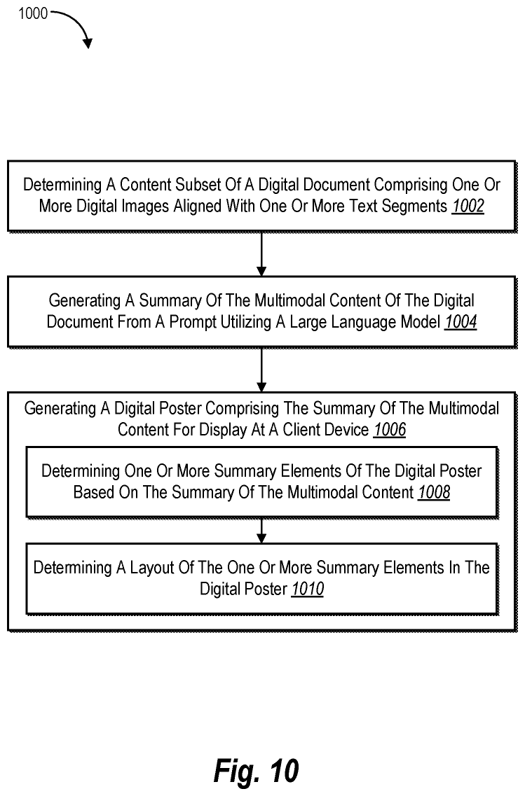

FIG. 10 illustrates an example series of acts 1000 for generating a digital poster including multimodal content by determining summary elements and a layout of the digital poster. The series of acts 1000 can include an act 1002 of determining a content subset of a digital document comprising one or more digital images aligned with one or more text segments; an act 1004 of generating a summary of the multimodal content of the digital document from a prompt utilizing a large language model; an act 1006 of generating a digital poster comprising the summary of the multimodal content for display at a client device; an act 1008 of determining one or more summary elements of the digital poster based on the summary of the multimodal content; and an act 1010 of determining a layout of the one or more summary elements in the digital poster.

In one or more implementations, the series of acts 1000 can include determining, from embedding vectors representing multimodal content of a digital document and utilizing a deep submodular function, a content subset including one or more digital images aligned with one or more text segments representative of the digital document. Additionally, the series of acts 1000 can include an act of generating, utilizing a large language model, a summary of the multimodal content of the digital document from a prompt based on the content subset. The series of acts 1000 can also include an act of generating, for display at a client device, a digital poster including the summary of the multimodal content generated via the large language model by determining one or more summary elements of the digital poster based on the summary of the multimodal content. The series of acts 1000 can further include an act of determining a layout of the one or more summary elements in the digital poster according to attributes of the one or more summary elements.

In some embodiments, the series of acts 1000 can include determining, utilizing one or more machine learning models, one or more design elements including one or more fonts or one or more colors of the digital poster based on the summary of the multimodal content.

In some implementations, determining, utilizing the one or more machine learning models, the one or more design elements of the digital poster includes determining a title of the digital poster from the summary of the multimodal content. Additionally, the series of acts 1000 can include an act of determining, utilizing a first machine learning model of the one or more machine learning models, a font for the digital poster from the title of the digital poster.

In one or more embodiments, the series of acts 1000 can include determining, utilizing a second machine learning model of the one or more machine learning models, a color palette based on the title of the digital document. Furthermore, in one or more implementations, the series of acts 1000 can include determining, utilizing color contrast ratios, a dominant color from colors of the color palette. The series of acts 1000 can also include an act of assigning the dominant color as a background color of the digital poster.

In some embodiments, the series of acts 1000 can include determining the layout of the one or more summary elements by determining, from the summary of the multimodal content, a number of the one or more summary elements. The series of acts 1000 can further include an act of determining, based on the number of the one or more summary elements and the attributes of the one or more summary elements, a spatial arrangement of the one or more summary elements.

In some implementations, determining the content subset of the digital document includes utilizing the deep submodular function to determine one or more embedding vectors that collectively summarize the digital document according to a coverage component of the deep submodular function. Additionally, the series of acts 1000 can include an act of providing diversity of the content subset by minimizing repetition of meaning across the one or more embedding vectors according to a diversity component of the deep submodular function. The series of acts 1000 can also include an act of aligning one or more text segment vectors with one or more image vectors according to an alignment component of the deep submodular function.

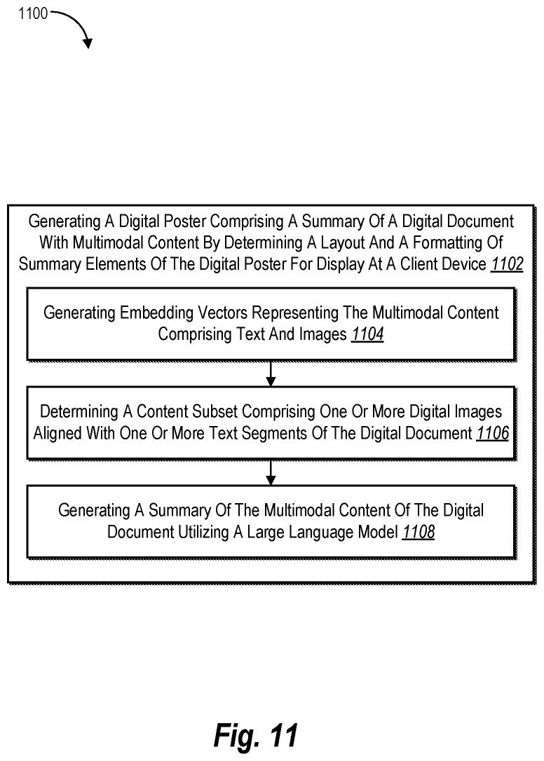

FIG. 11 illustrates an example series of acts 1100 for generating a digital poster for display at a client device by determining a layout and formatting of summary elements of the digital poster. The series of acts 1100 can include an act 1102 of generating a digital poster comprising a summary of a digital document with multimodal content by determining a layout and a formatting of summary elements of the digital poster for display at a client device; an act 1104 of generating embedding vectors representing the multimodal content comprising text and images; an act 1106 of determining a content subset comprising one or more digital images aligned with one or more text segments of the digital document; an act 1108 of generating a summary of the multimodal content of the digital document utilizing a large language model.

In one or more embodiments, the series of acts 1100 can include generating, by at least one processor utilizing an encoder neural network, embedding vectors representing multimodal content of a digital document including text and images. The series of acts 1100 can further include an act of determining, by the at least one processor and utilizing a deep submodular function on the embedding vectors, a content subset including one or more digital images aligned with one or more text segments representative of the digital document. Additionally, the series of acts 1100 can include an act of generating, utilizing a large language model, a summary of the multimodal content of the digital document from a prompt based on the content subset. The series of acts 1100 can also include an act of generating, for display at a client device, a digital poster including the summary of the multimodal content generated via the large language model by determining a layout and a formatting of one or more summary elements of the digital poster based on the summary of the multimodal content.

In one or more implementations, determining the content subset includes determining, utilizing the deep submodular function, one or more embedding vectors that collectively summarize the digital document according to a coverage component of the deep submodular function. Additionally or alternatively, in some embodiments, determining the content subset includes determining, utilizing the deep submodular function, one or more embedding vectors that provide diversity across the content subset by minimizing repetition of meaning across the one or more embedding vectors according to a diversity component of the deep submodular function. Additionally or alternatively, in some implementations, determining the content subset includes determining, utilizing the deep submodular function, one or more text segment vectors that align with one or more image vectors according to an alignment component of the deep submodular function.

In one or more embodiments, the series of acts 1100 can include determining the layout by determining, from the summary of the multimodal content, a number of the one or more summary elements. The series of acts 1100 can further include an act of determining, by a layout determination model and based on the number of the one or more summary elements and attributes of the one or more summary elements, a spatial arrangement of the one or more summary elements.

In one or more implementations, the series of acts 1100 can include determining, utilizing one or more machine learning models, one or more design elements of the digital poster based on the summary of the multimodal content by determining a title of the digital poster from the summary of the multimodal content. Additionally, the series of acts 1100 can include an act of determining, utilizing a first machine learning model of the one or more machine learning models, a font for the digital poster from the title of the digital poster. The series of acts 1100 can also include an act of or determining, utilizing a second machine learning model of the one or more machine learning models, a color palette based on the title of the digital poster.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server(s) 102 and/or the client device 110) that may be configured to perform one or more of the processes described above. One will appreciate that server(s) 102 and/or the client device 110 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, by at least one processor utilizing an encoder neural network, embedding vectors representing multimodal content of a digital document comprising text and images;
determining, by the at least one processor and utilizing a deep submodular function on the embedding vectors, a content subset comprising one or more digital images aligned with one or more text segments representative of the digital document;
generating, utilizing a large language model, a summary of the multimodal content of the digital document from a prompt based on the content subset; and
generating, by the at least one processor and for display at a client device, a digital poster comprising the summary of the multimodal content generated via the large language model.

2. The computer-implemented method of claim 1, wherein generating the embedding vectors representing the multimodal content of the digital document comprises:
extracting the text and the images of the digital document;
determining text segments from the extracted text of the digital document; and
generating, utilizing the encoder neural network, the embedding vectors representing the text segments and the images in a single embedding space.

3. The computer-implemented method of claim 1, wherein determining the content subset comprises determining, utilizing the deep submodular function, one or more embedding vectors that collectively summarize the digital document according to a coverage component of the deep submodular function.

4. The computer-implemented method of claim 1, wherein determining the content subset comprises determining, utilizing the deep submodular function, one or more embedding vectors that provide diversity of meaning across the content subset by minimizing repetition of meaning across the one or more embedding vectors according to a diversity component of the deep submodular function.

5. The computer-implemented method of claim 1, wherein determining the content subset comprises determining, utilizing the deep submodular function, one or more text segment vectors that align with one or more image vectors according to an alignment component of the deep submodular function.

6. The computer-implemented method of claim 1, wherein determining the content subset by utilizing the deep submodular function on the embedding vectors comprises determining at least one of a coverage component, a diversity component, or an alignment component of the deep submodular function by iteratively optimizing a chosen embedding vector subset and weights of the submodular function to maximize the deep submodular function.

7. The computer-implemented method of claim 1, further comprising adjusting parameters of the deep submodular function in a framework of a neural network by reducing an output of a loss function utilizing a projected gradient descent algorithm with a fixed learning rate.

8. A system comprising:
one or more memory devices; and
one or more processors configured to cause the system to:
determine, from embedding vectors representing multimodal content of a digital document and utilizing a deep submodular function, a content subset comprising one or more digital images aligned with one or more text segments representative of the digital document;
generate, utilizing a large language model, a summary of the multimodal content of the digital document from a prompt based on the content subset; and
generate, for display at a client device, a digital poster comprising the summary of the multimodal content generated via the large language model by:
determining one or more summary elements of the digital poster based on the summary of the multimodal content; and
determining a layout of the one or more summary elements in the digital poster according to attributes of the one or more summary elements.

9. The system of claim 8, wherein the one or more processors are further configured to determine, utilizing one or more machine learning models, one or more design elements comprising one or more fonts or one or more colors of the digital poster based on the summary of the multimodal content.

10. The system of claim 9, wherein determining, utilizing the one or more machine learning models, the one or more design elements of the digital poster comprises:
determining a title of the digital poster from the summary of the multimodal content; and
determining, utilizing a first machine learning model of the one or more machine learning models, a font for the digital poster from the title of the digital poster.

11. The system of claim 10, wherein the one or more processors are further configured to determine, utilizing a second machine learning model of the one or more machine learning models, a color palette based on the title of the digital document.

12. The system of claim 11, wherein the one or more processors are further configured to:
determine, utilizing color contrast ratios, a dominant color from colors of the color palette; and
assign the dominant color as a background color of the digital poster.

13. The system of claim 8, wherein the one or more processors are further configured to determine the layout of the one or more summary elements by:
determining, from the summary of the multimodal content, a number of the one or more summary elements; and
determining, based on the number of the one or more summary elements and the attributes of the one or more summary elements, a spatial arrangement of the one or more summary elements.

14. The system of claim 8, wherein determining the content subset of the digital document comprises utilizing the deep submodular function to determine one or more embedding vectors that:
collectively summarize the digital document according to a coverage component of the deep submodular function;
provide diversity of the content subset by minimizing repetition of meaning across the one or more embedding vectors according to a diversity component of the deep submodular function; and
align one or more text segment vectors with one or more image vectors according to an alignment component of the deep submodular function.

15. A non-transitory computer readable medium storing executable instructions which, when executed by a processing device, cause the processing device to perform operations comprising:
generate, by at least one processor utilizing an encoder neural network, embedding vectors representing multimodal content of a digital document comprising text and images;
determine, by the at least one processor and utilizing a deep submodular function on the embedding vectors, a content subset comprising one or more digital images aligned with one or more text segments representative of the digital document;
generate, utilizing a large language model, a summary of the multimodal content of the digital document from a prompt based on the content subset; and
generate, for display at a client device, a digital poster comprising the summary of the multimodal content generated via the large language model by determining a layout and a formatting of one or more summary elements of the digital poster based on the summary of the multimodal content.

16. The non-transitory computer readable medium of claim 15, wherein determining the content subset comprises determining, utilizing the deep submodular function, one or more embedding vectors that collectively summarize the digital document according to a coverage component of the deep submodular function.

17. The non-transitory computer readable medium of claim 15, wherein determining the content subset comprises determining, utilizing the deep submodular function, one or more embedding vectors that provide diversity across the content subset by minimizing repetition of meaning across the one or more embedding vectors according to a diversity component of the deep submodular function.

18. The non-transitory computer readable medium of claim 15, wherein determining the content subset comprises determining, utilizing the deep submodular function, one or more text segment vectors that align with one or more image vectors according to an alignment component of the deep submodular function.

19. The non-transitory computer readable medium of claim 15, wherein the operations further comprise determining the layout by:
determining, from the summary of the multimodal content, a number of the one or more summary elements; and
determining, by a layout determination model and based on the number of the one or more summary elements and attributes of the one or more summary elements, a spatial arrangement of the one or more summary elements.

20. The non-transitory computer readable medium of claim 15, wherein the operations further comprise determining, utilizing one or more machine learning models, one or more design elements of the digital poster based on the summary of the multimodal content by:
determining a title of the digital poster from the summary of the multimodal content; and
determining, utilizing a first machine learning model of the one or more machine learning models, a font for the digital poster from the title of the digital poster; or
determining, utilizing a second machine learning model of the one or more machine learning models, a color palette based on the title of the digital poster.
